(19) United States
(12) Patent Application Publication
(10) Pub. No.: US 2009/0070839 A1
(43) Pub. Date: Mar. 12, 2009

(54) SYSTEM FOR ADJUSTING ENCODING RATES BETWEEN COMMUNICATION DEVICES

(75) Inventors: JAMES L. CANSLER, PFLUGERVILLE, TX (US); SCOTT WHITE, AUSTIN, TX (US)

Correspondence Address: AKERMAN SENTERFITT, P.O. BOX 3188, WEST PALM BEACH, FL, 33402-3188, US

(73) Assignee: AT&T KNOWLEDGE VENTURES, L.P., RENO, NV (US)

(21) Appl. No.: 11/853,303

(22) Filed: Sep. 11, 2007

(51) Int. Cl. H04N 7/173

(52) U.S. Cl. 725/110

(57) ABSTRACT

A system that incorporates teachings of the present disclosure may include, for example, a first communication device having a controller adapted to determine whether a second communication device is operating within or remote to a local area network of the first communication device, determine an encoding rate according to said determination, and transmit to the second communication device streamed media content according to said encoding rate. Other embodiments are disclosed.

### FIELD OF THE DISCLOSURE

The present disclosure relates generally to media content processing techniques and more specifically to a system for adjusting encoding rates between communication devices.

### BACKGROUND

Streaming video and audio content has become a popular form of communication. In an ad hoc network such as the Internet streamed content can be interrupted by traffic anomalies. The interruption experienced by a receiving communication device can result in a pause or clipping of the audio and/or video presentation. In local area networks or intranet environments such interruptions are typically less prevalent.

### BRIEF DESCRIPTION OF THE DRAWINGS

FIG. 1 depicts an exemplary embodiment of a communication system;

FIG. 2 depicts an exemplary embodiment of a portal of the communication system;

FIG. 3 depicts an exemplary method operating in portions of the communication system; and

FIG. 4 is a diagrammatic representation of a machine in the form of a computer system within which a set of instructions, when executed, may cause the machine to perform any one or more of the methodologies discussed herein.

### DETAILED DESCRIPTION

In one embodiment of the present disclosure, a computer-readable storage medium operating in a first communication device can have computer instructions for establishing communications with a second communication device, receiving from the second communication device network connectivity information comprising at least one among an Internet Protocol (IP) address, a subnet address, and a default gateway address assigned to the second communication device, determining an encoding rate for streaming media content to the second communication device by comparing the network connectivity information of the second communication device to network connectivity information of the first communication device, receiving from the second communication device a request for streamed media content, and transmitting to the second communication device streamed media content at the encoding rate.

In one embodiment of the present disclosure, a first communication device can have a controller adapted to determine whether a second communication device is operating within or remote to a Local Area Network (LAN) of the first communication device, determine an encoding rate according to said determination, and transmit to the second communication device streamed media content according to said encoding rate.

In one embodiment of the present disclosure, a first communication device can have a controller adapted to assist a second communication device to determine an encoding rate for transmitting streamed media content to the first communication device based on whether the first communication device is operating within or remote to a Local Area Network (LAN) of the second communication devices.

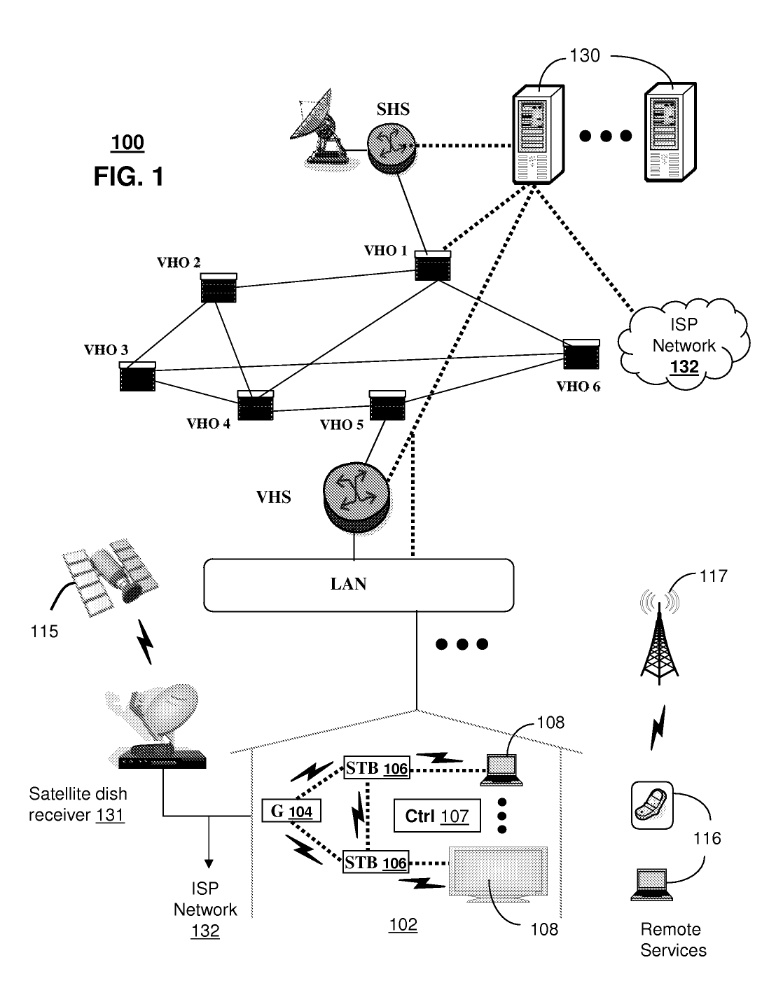

FIG. 1 depicts an exemplary embodiment of a communication system 100. The communication system 100 can represent an IPTV broadcast media system. In a typical IPTV infrastructure, there is at least one super head office server (SHS) which receives national media programs from satellite and/or media servers from service providers of multimedia broadcast channels. In the present context, media programs can represent audio only content, video only content, and combinations thereof. The SHS server forwards IP packets associated with the media content to video head servers (VHS) via a network of video head offices (VHO) according to a common multicast communication method.

The VHS then distributes multimedia broadcast programs to commercial and/or residential buildings 102 housing a gateway 104 (e.g., a residential gateway or RG). The gateway 104 distributes broadcast signals to media content processors 106 such as Set-Top Boxes (STBs) which in turn present broadcast selections to media devices 108 such as computers or television units managed in some instances by a media controller 107 (e.g., an infrared or RF remote control). Unicast traffic can also be exchanged between the media content processors 106 and subsystems of the IPTV media system for services such as video-on-demand (VoD).

The IPTV media system can be coupled to one or more computing devices 130 that can operate as a web or Internet server for providing portal services over an Internet Service Provider (ISP) network 132 to fixed media devices 108 or portable communication devices 116 by way of a wireless base station 117 such as in a cellular communication network operating with common protocols (GSM, CDMA, etc.).

A satellite broadcast system can be used in place of the IPTV media system. In this embodiment, signals transmitted by a satellite 115 can be intercepted by a satellite dish receiver 131 coupled to building 102 which conveys satellite media signals to the media content processors 106 by way of gateway 104. Alternatively, the satellite signals can be received and processed by the media content processor 106 over a satellite port of the media content processor coupled to the satellite dish receiver 131. The media content processors 106 can also be equipped with a broadband port that couples to the ISP network 132 for general broadband access.

Although not shown, the communication system 100 can also be combined or replaced with analog or digital broadcast distributions systems such as cable TV systems. It would be apparent therefore to one of ordinary skill in the art that the present disclosure can be applied to any media content system.

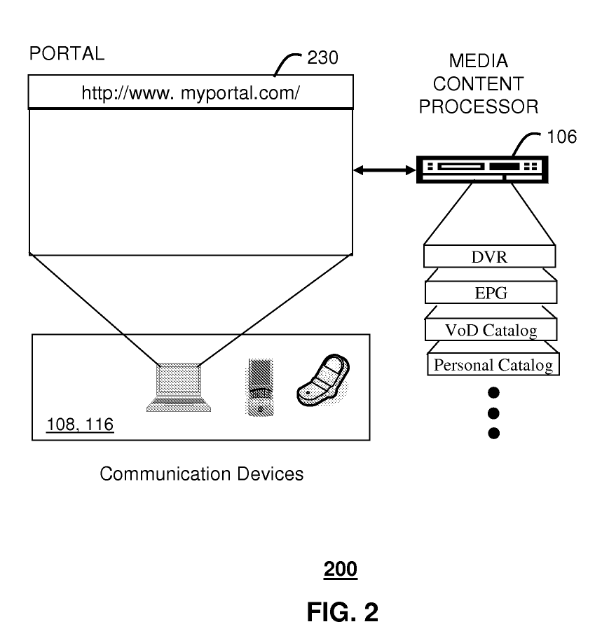

FIG. 2 depicts an exemplary embodiment of a portal 230 of the communication system 100. In FIG. 2, the portal 230 can be accessed by a URL with a common browser such as Microsoft's Internet Explorer using an Internet-capable fixed or portable communication device 108, 116. The portal 230 can be configured to access a media content processor 106 such as the STB of FIG. 1 and services managed thereby such as a Digital Video Recorder (DVR), an Electronic Programming Guide (EPG), Video on Demand (VoD) catalog, a personal catalog stored in the STB (e.g., personal videos, pictures, audio recordings, etc.), and so on by way of the gateway 104. The portal 230 can direct the media content processor 106 to stream media content to a fixed or portable communication device 108, 116 accessing the portal.

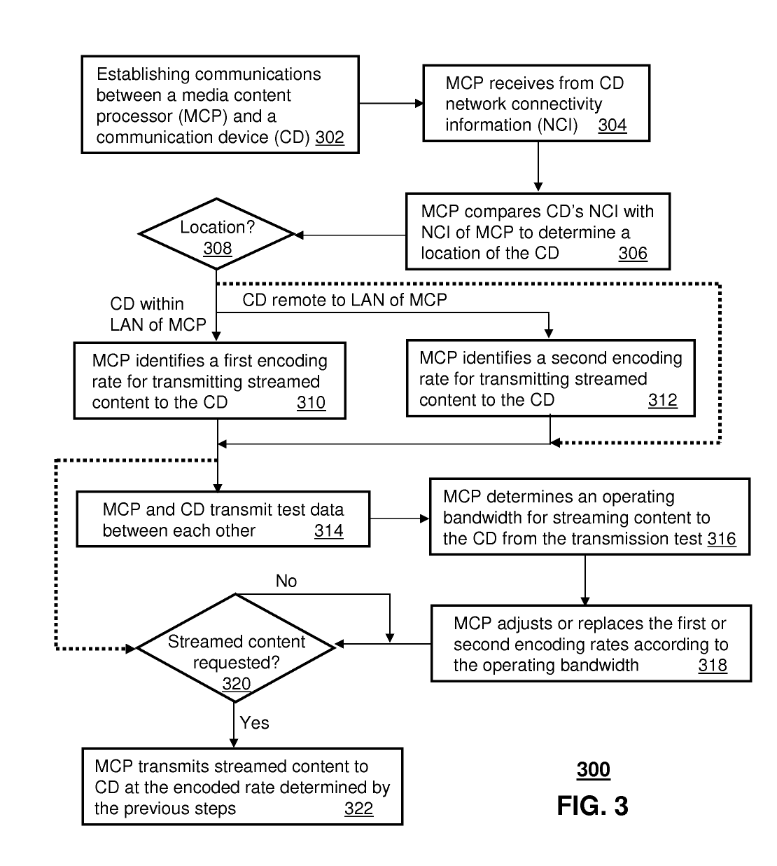

FIG. 3 depicts an exemplary method 300 operating in portions of the communication system 100. Method 300 begins with step 302 in which a media content processor (MCP) 106 establishes communications with a fixed or portable communication device (CD). In the case of a fixed CD 108, the CD can be a computing device such as a laptop or desktop computer located in building 102 where the MCP 106 is situated, or in another building such as an office building, an airport, or other facility remote from the MCP 106. In the case where the fixed CD 108 is situated in the same building as the MCP 106, the CD 108 can operate from the same Local Area Network (LAN) of the MCP. The LAN can be a wired network (e.g., Ethernet over power lines, xDSL, etc.) or wireless network (e.g., a WiFi network).

In the situation where the CD 108 is located outside the bounds of the building 102 in which the MCP 106 is situated, the CD can establish communications with the MCP 106 by way of portal 230 over the ISP network 132. The portal 230 can serve as a central means for remote access to the MCP 106 and can serve to direct the MCP to perform a number of activities requested by the CD 108. For MCPs 106 with abundant computing resources and sophisticated communication capabilities, the CD 108 can remotely communicate with the MCP over the ISP 132 and provide a user interface similar to what portal 230 can provide.

In situations where the CD is portable 116, communications between the MCP 106 and the CD will generally be remote to the LAN of the MCP unless the CD is situated in building 102 with the MCP. In this latter case, the CD 106 can establish communications with the MCP 106 over its LAN by common wireless or wired means.

For illustration purposes, CD 108 will be used as an exemplary embodiment for the subsequent steps of method 300. It should be understood however that CD 108 can be interchanged with CD 116 without affecting the scope of method 300.

With this in mind, once communications have been established in step 302 between the MCP 106 and the CD 108, the MCP can expect in step 304 to receive from the CD network connectivity information (NCI). The NCI can be proactively transmitted by the CD 108 or can be requested by the MCP 106 after communications have been established. The NCI can correspond to any form of network connectivity information that can assist the MCP 106 in determining an adequate encoding rate for transmitting streamed data to the CD 108. The NCI can comprise for example an Internet Protocol (IP) address, a subnet address and/or a default gateway address assigned to the CD 108, 116.

The MCP 106 can compare in step 306 the NCI of the CD 108 to its own NCI to determine whether the CD is presently located in its LAN. For example, if the MCP 106 and the CD 108 have the same subnet address, the MCP can assume that the CD is operating from its LAN. The MCP 106 can also request from gateway 104 IP addresses and default gateway addresses it has assigned to devices in its network. The MCP 106 can make a determination that the CD is operating from its LAN if either the IP address or default gateway address supplied by the CD matches one of the addresses supplied by the gateway 104.

Once the MCP 106 determines a location for the CD 108 in step 308, it can proceed to either step 310 or step 312. If the CD 108 is located in the LAN of the MCP 106, the MCP can assign a first encoding rate for transmitting streamed content to the CD. Alternatively, if the CD 108 is operating in a network remote to the LAN of the MCP 106, the MCP can assign a second encoding rate for transmitting streamed content to the CD. Generally, the bandwidth and Quality of Service (QoS) characteristics of the LAN will be superior to the bandwidth and QoS of a network coupled to the LAN by way of for example ISP network 132. Consequently, the first encoding rate is likely to exceed the second encoding rate. Accordingly, a subscriber of the CD 108 is bound to experience a better quality of presentation of streamed media content (audio, video or combinations thereof) when located in the LAN than remotely from the LAN.

The MCP 106 can be programmed in steps 310 and 312 to select the first and second encoding rates in a manner that maximizes the quality of presentation of streamed media content without exceeding the QoS limitations of the LAN or network thereto. By knowing an approximate location of the CD 108, the MCP 106 can distinguish which of two possible encoding rates to choose from in order to avoid exceeding bandwidth limits of the network connection therebetween. With this selection process, the MCP 106 can minimize the impact of common network anomalies experienced in ad hoc networks such as temporary bursts of traffic which can cause buffer overruns, jitter, packet losses, retransmissions, each singly or collectively causing a temporary pause or clipping of the streamed content.

The first and second encoding rates can be predefined by the service provider of communication system 100 based on known statistics of the communication system 100. Alternatively, the first and second encoding rates can be statistically determined from real-time monitoring performed by the MCP 106 or by a network element in the communication system 100 (e.g., a network management system) tasked to monitor intra-network (i.e., LAN activity of each MCP in the communication system) and inter-network activities (e.g., ISP network 132 and other intermediary networks such as inter-operator networks coupled thereto). The network element can periodically convey its findings to the MCP 106 to update the first and second encoding rates.

As a supplemental embodiment, the MCP 106 and CD 108 can be further programmed to transmit in step 314 test data therebetween. The test data can be streamed data transmitted from the MCP 106 to the CD 108, vice-versa, or in both directions in one or more iterations. The test data can be of any size formatted for example as a packet stream operating according to a Real-time Transport Protocol (RTP). The test RTP stream(s) can be used by the MCP 106 to develop common telemetry data at the MCP and the CD 108 (e.g., bit error rate, packet loss rate, latency, number of sequence number gaps between packets, etc.).

From the telemetry information the MCP 106 can determine an operating bandwidth for adequately streaming content to the CD 108. In step 318 the MCP 106 can adjust either of the encoding rates of steps 314 or 316, or replace them with a new encoding rate according to the operating bandwidth of step 316. Once an encoding rate has been determined, the MCP 106 can receive requests in step 320 from the CD 108 to present a selected media file stored in the MCP. Upon detecting such a request, the MCP 106 transcodes the selected media content and transmits it in step 322 as stream media content at the encoding rate determined in one of steps 310, 312 and 318.

Upon reviewing the aforementioned embodiments, it would be evident to an artisan with ordinary skill in the art that said embodiments can be modified, reduced, or enhanced without departing from the scope and spirit of the claims described below. For example, method 300 can be adapted to skip steps 314-318 as shown in FIG. 3 and rely on a selection of the first or second encoding rates in steps 310-312. Similarly, method 300 can be adapted to skip steps 310-312 and utilize the testing procedure of steps 314-318 to determine an adequate encoding rate for the CD 108. In more general terms, method 300 can be applied between any pair of communication devices not just an MCP 106. For example, method 300 can be applied to a laptop computer streaming data to a cell phone in or outside of the laptop computer's LAN as described in method 300. The same can be said of a cell phone applying method 300 to stream data to a laptop computer operating in or outside of the cell phone's LAN. It follows therefore that any combination of communication devices can apply the principles of method 300.

These are but a few examples of modifications that can be applied to the present disclosure without departing from the scope of the claims. Accordingly, the reader is directed to the claims section for a fuller understanding of the breadth and scope of the present disclosure.

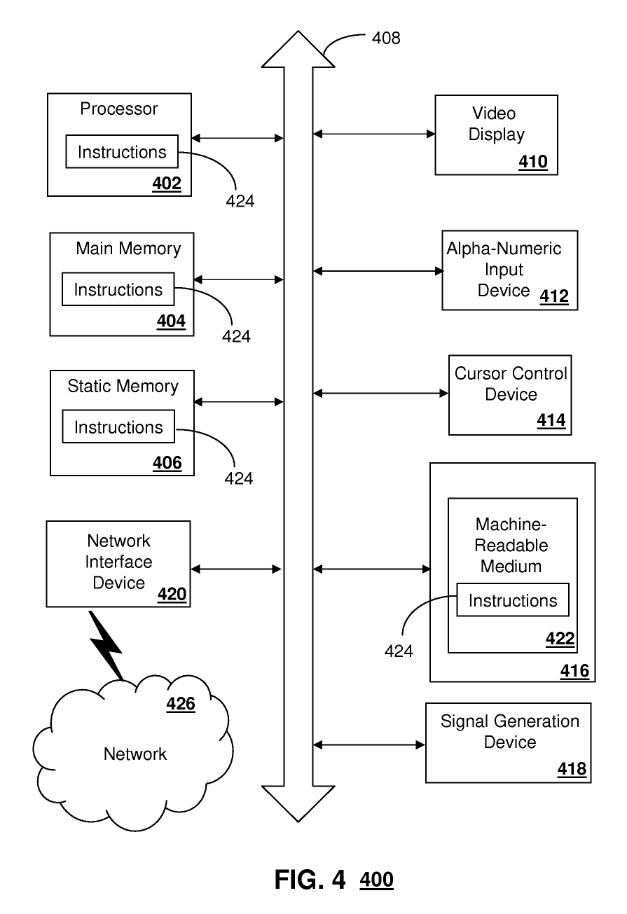

FIG. 4 depicts an exemplary diagrammatic representation of a machine in the form of a computer system 400 within which a set of instructions, when executed, may cause the machine to perform any one or more of the methodologies discussed above. In some embodiments, the machine operates as a standalone device. In some embodiments, the machine may be connected (e.g., using a network) to other machines. In a networked deployment, the machine may operate in the capacity of a server or a client user machine in server-client user network environment, or as a peer machine in a peer-to-peer (or distributed) network environment.

The machine may comprise a server computer, a client user computer, a personal computer (PC), a tablet PC, a laptop computer, a desktop computer, a control system, a network router, switch or bridge, or any machine capable of executing a set of instructions (sequential or otherwise) that specify actions to be taken by that machine. It will be understood that a device of the present disclosure includes broadly any electronic device that provides voice, video or data communication. Further, while a single machine is illustrated, the term “machine” shall also be taken to include any collection of machines that individually or jointly execute a set (or multiple sets) of instructions to perform any one or more of the methodologies discussed herein.

The computer system 400 may include a processor 402 (e.g., a central processing unit (CPU), a graphics processing unit (GPU, or both), a main memory 404 and a static memory 406, which communicate with each other via a bus 408. The computer system 400 may further include a video display unit 410 (e.g., a liquid crystal display (LCD), a flat panel, a solid state display, or a cathode ray tube (CRT)). The computer system 400 may include an input device 412 (e.g., a keyboard), a cursor control device 414 (e.g., a mouse), a disk drive unit 416, a signal generation device 418 (e.g., a speaker or remote control) and a network interface device 420.

The disk drive unit 416 may include a machine-readable medium 422 on which is stored one or more sets of instructions (e.g., software 424) embodying any one or more of the methodologies or functions described herein, including those methods illustrated above. The instructions 424 may also reside, completely or at least partially, within the main memory 404, the static memory 406, and/or within the processor 402 during execution thereof by the computer system 400. The main memory 404 and the processor 402 also may constitute machine-readable media.

Dedicated hardware implementations including, but not limited to, application specific integrated circuits, programmable logic arrays and other hardware devices can likewise be constructed to implement the methods described herein. Applications that may include the apparatus and systems of various embodiments broadly include a variety of electronic and computer systems. Some embodiments implement functions in two or more specific interconnected hardware modules or devices with related control and data signals communicated between and through the modules, or as portions of an application-specific integrated circuit. Thus, the example system is applicable to software, firmware, and hardware implementations.

In accordance with various embodiments of the present disclosure, the methods described herein are intended for operation as software programs running on a computer processor. Furthermore, software implementations can include, but not limited to, distributed processing or component/object distributed processing, parallel processing, or virtual machine processing can also be constructed to implement the methods described herein.

The present disclosure contemplates a machine readable medium containing instructions 424, or that which receives and executes instructions 424 from a propagated signal so that a device connected to a network environment 426 can send or receive voice, video or data, and to communicate over the network 426 using the instructions 424. The instructions 424 may further be transmitted or received over a network 426 via the network interface device 420.

While the machine-readable medium 422 is shown in an example embodiment to be a single medium, the term “machine-readable medium” should be taken to include a single medium or multiple media (e.g., a centralized or distributed database, and/or associated caches and servers) that store the one or more sets of instructions. The term “machine-readable medium” shall also be taken to include any medium that is capable of storing, encoding or carrying a set of instructions for execution by the machine and that cause the machine to perform any one or more of the methodologies of the present disclosure.

The term “machine-readable medium” shall accordingly be taken to include, but not be limited to: solid-state memories such as a memory card or other package that houses one or more read-only (non-volatile) memories, random access memories, or other re-writable (volatile) memories; magneto-optical or optical medium such as a disk or tape; and carrier wave signals such as a signal embodying computer instructions in a transmission medium; and/or a digital file attachment to e-mail or other self-contained information archive or set of archives is considered a distribution medium equivalent to a tangible storage medium. Accordingly, the disclosure is considered to include any one or more of a machine-readable medium or a distribution medium, as listed herein and including art-recognized equivalents and successor media, in which the software implementations herein are stored.

Although the present specification describes components and functions implemented in the embodiments with reference to particular standards and protocols, the disclosure is not limited to such standards and protocols. Each of the standards for Internet and other packet switched network transmission (e.g., TCP/IP, UDP/IP, HTML, HTTP) represent examples of the state of the art. Such standards are periodically superseded by faster or more efficient equivalents having essentially the same functions. Accordingly, replacement standards and protocols having the same functions are considered equivalents.

The illustrations of embodiments described herein are intended to provide a general understanding of the structure of various embodiments, and they are not intended to serve as a complete description of all the elements and features of apparatus and systems that might make use of the structures described herein. Many other embodiments will be apparent to those of skill in the art upon reviewing the above description. Other embodiments may be utilized and derived therefrom, such that structural and logical substitutions and changes may be made without departing from the scope of this disclosure. Figures are also merely representational and may not be drawn to scale. Certain proportions thereof may be exaggerated, while others may be minimized. Accordingly, the specification and drawings are to be regarded in an illustrative rather than a restrictive sense.

Such embodiments of the inventive subject matter may be referred to herein, individually and/or collectively, by the term “invention” merely for convenience and without intending to voluntarily limit the scope of this application to any single invention or inventive concept if more than one is in fact disclosed. Thus, although specific embodiments have been illustrated and described herein, it should be appreciated that any arrangement calculated to achieve the same purpose may be substituted for the specific embodiments shown. This disclosure is intended to cover any and all adaptations or variations of various embodiments. Combinations of the above embodiments, and other embodiments not specifically described herein, will be apparent to those of skill in the art upon reviewing the above description.

The Abstract of the Disclosure is provided to comply with 37 C.F.R. § 1.72(b), requiring an abstract that will allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in a single embodiment for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separately claimed subject matter.

What is claimed is:

1. A computer-readable storage medium operating in a first communication device, comprising computer instructions for:
establishing communications with a second communication device;
receiving from the second communication device network connectivity information comprising at least one among an Internet Protocol (IP) address, a subnet address, and a default gateway address assigned to the second communication device;
determining an encoding rate for streaming media content to the second communication device by comparing the network connectivity information of the second communication device to network connectivity information of the first communication device;
receiving from the second communication device a request for streamed media content; and
transmitting to the second communication device streamed media content at the encoding rate.

2. The storage medium of claim 1, wherein media content corresponds to one among audio content, video content and combinations thereof.

3. The storage medium of claim 1, comprising computer instructions for determining a network location of the second communication device from the network connectivity information supplied thereby.

4. The storage medium of claim 3, comprising computer instructions for determining the encoding rate according to the network location.

5. The storage medium of claim 3, comprising computer instructions for:
determining from the network location that the second communication device is operating in a Local Area Network (LAN) of the first communication device or is operating in a network remote to the LAN; and
assigning the encoding rate a first encoding rate when the second communication device is operating in the LAN; and
assigning the encoding rate a second encoding rate when the second communication device is operating in the network remote to the LAN.

6. The storage medium of claim 5, wherein the first encoding rate is greater than or equal to the second encoding rate.

7. The storage medium of claim 1, comprising computer instructions for:
transmitting data between the first and second communication devices; and
determining the encoding rate from the transmission of said data and the comparison step.

8. The storage medium of claim 7, comprising computer instructions for determining from the transmission of data between the first and second communication devices an operating bandwidth for streaming media content to the second communication device.

9. The storage medium of claim 1, wherein the first communication device comprises a media content processor operating in one among an Internet Protocol Television (IPTV) communication system, a satellite TV communication system, and a cable TV communication system, and wherein the second communication device comprises one among a fixed and portable communication device.

10. A first communication device, comprising a controller adapted to:
determine whether a second communication device is operating within or remote to a Local Area Network (LAN) of the first communication device;
determine an encoding rate according to said determination; and
transmit to the second communication device streamed media content according to said encoding rate.

11. The first communication device of claim 10, wherein the controller is adapted to:
receive from the second communication device network connectivity information; and
determine from the network connectivity information whether the second communication device is operating within or remote to the LAN.

12. The first communication device of claim 11, wherein the network connectivity information comprises at least one among an Internet Protocol (IP) address, a subnet address, and a default gateway address assigned to the second communication device.

13. The first communication device of claim 11, wherein the controller is adapted to:
compare the network connectivity information of the first communication device with network connectivity information of the second communication device; and
determine from said comparison whether the second communication device is operating within or remote to the LAN.

14. The first communication device of claim 10, wherein the controller is adapted to determine whether the second communication device is operating within or remote to the LAN according to test data transmitted between the first and second communication devices.

15. The first communication device of claim 10, wherein the controller is adapted to:
assign the encoding rate a first encoding rate when the second communication device is operating within the LAN; and
assign the encoding rate a second encoding rate when the second communication device is operating in a network remote to the LAN.

16. The first communication device of claim 10, wherein the first communication device comprises a Set-Top Box (STB) receiver operating in one among an Internet Protocol Television (IPTV) communication system, a satellite TV communication system, and a cable TV communication system, and wherein the second communication device comprises one among a fixed and portable communication device.

17. A first communication device, comprising a controller adapted to assist a second communication device to determine an encoding rate for transmitting streamed media content to the first communication device based on whether the first communication device is operating within or remote to a Local Area Network (LAN) of the second communication device.

18. The first communication device of claim 17, wherein the controller is adapted to transmit to the second communication device network connectivity information, and wherein the second communication device compares the network connectivity information of the first communication device to network connectivity information of the second communication device to determine the encoding rate.

19. The first communication device of claim 17, wherein the network connectivity information comprises at least one among an Internet Protocol (IP) address, a subnet address, and a default gateway address assigned to the second communication device.

20. The first communication device of claim 17, wherein test data is transmitted between the first and second communication devices to determine whether the first communication device is operating within or remote to the LAN of the second communication device.
